(19) United States
(12) Patent Application Publication
(10) Pub. No.: US 2015/0081445 A1
(43) Pub. Date: Mar. 19, 2015

(54) METHOD AND APPARATUS FOR GEOLOCATION OF A NETWORK USER

(71) Applicant: EBAY INC., San Jose, CA (US)

(72) Inventors: Jeffrey William Taylor, Los Altos, CA (US); Tong Li, San Jose, CA (US)

(21) Appl. No.: 14/501,649

(22) Filed: Sep. 30, 2014

Related U.S. Application Data
(63) Continuation of application No. 10/674,054, filed on Sep. 29, 2003.

(51) Int. Cl. G06Q 30/02; H04L 12/26

(52) U.S. Cl. CPC G06Q 30/0261; H04L 43/04
USPC 705/14.58

(57) ABSTRACT

A database correlating the geographic locations of users of a network to the network address through which the users access the network is maintained and used to infer the geographic location of other users of the network that access the website through the same IP addresses. An Internet website operator may generate such a database from home or business address information self-reported by users of the website. If a plurality of users that access a website through the same IP address have self-reported information as to their geographic location to a website operator, that information collectively provides information as to the likely geographic location and the geographic diversity of other users that access the network through that IP address. Accordingly, such information is used to infer the extent to which a given IP address is likely to correlate to any particular geographic area and the particular area. Additionally, a website operator that has information indicative of the veracity of the self-reported location information may use that information to rate the likelihood that the self-reported location information for a given user is truthful and then use that rating to provide an even more accurate rating of the likelihood that an inferred location of a user is in a given location.

### RELATED APPLICATIONS

This application is a continuation of U.S. application Ser. No. 10/674,054, filed Sep. 29, 2003, which is incorporated in its entirely.

### TECHNICAL FIELD

The invention relates to determining the geographic location of users of a communication network, such as the Internet.

### BACKGROUND

It often is desirable or necessary to know the geographic location of an individual using a communication network, such as the Internet, without directly asking the user to provide such information. One person or entity located at one node of a network and using the network to communicate with another person or entity at another node on the network may wish to determine the geographic location of the other person. More specifically, in the context of the Internet, it often is desirable for an individual or enterprise operating a website, particularly a business website, to know the geographic location of individual users that visit the website.

The geographic location of users visiting a website can be desirable or useful information for several reasons. For instance, it can help a website operator provide geographically targeted advertising, such as banner advertisements and pop-up advertisements, to its users. Geographically targeted advertising may help increase the website operator's advertising revenue. It also should enhance the Website visitors' experience while visiting the website by providing them advertising that is more particularly of interest to them. Another possible use for such information pertains to regulatory compliance. For instance, a website operator may need to know the geographic location of the user in order to assure that it complies with the laws and regulations of that jurisdiction. For instance, a gambling site may need to prevent a user located in a sovereignty that prohibits online gambling from gambling on that website.

Yet another potential use for such geographic location information pertains to compliance with licensing distribution agreements. For instance, a website operator may have a geographically limited license to sell or use a certain product and, therefore, would not be permitted, under its licensing agreement, to sell a product to a person in a certain geographic location.

One way to obtain such information is to ask a visitor to the Website to provide such information (hereinafter termed “self-reporting”). For example, the Website operator may have a Web page that the visitor first may be required or requested to view in order to access certain pages of the Website in which the user is provided with a form in which the user can or must input personal information such as home address or current location. However, this may not be practical for many reasons. For instance, users simply may not wish to provide such information. Further, even those users that may not be adverse to providing such information simply may not wish to take the time and go through the trouble of entering such information. Accordingly, it would be useful to be able to determine such geolocation information of Website users without actually requesting the user to input such information.

In fact, even when self-reported geolocation data is available, independent verification of such self-reported geolocation data often is desirable for purposes of fraud detection/prevention. For instance, persons legitimately transacting business (e.g., making a purchase) via the Internet typically will be located at their home or workplace, whereas a person attempting to fraudulently transact business over the Internet (e.g., trying to purchase goods or services with a stolen credit card) will be located at a place remote from the home address of the person to whom the credit card actually belongs. As part of fraud detection, it may be useful to know the actual geographic location of the individual in order to compare it to presently or previously self-reported geographic information and/or the billing address for the credit card.

Several enterprises presently offer website operators data as to the geographic location of online visitors to a website as a function of the user's IP addresses (which basically is inherently provided to a website as part of every request for access to the website) based on a mapping of the Internet infrastructure. It is believed that the technology used for locating a website visitor based on the user's IP address involves determining the location of the server computer through which the individual is connecting to the Internet. For example, this might be a server owned and operated by that user's Internet service provider (ISP) or a business enterprise. It is believed that the location of such servers is determined by a sort of trilateration technique involving sending requests to the target server from a plurality of different servers on the network that are located at geographically remote locations from each other. For each request received, the target server will send back a reply to the requesting server. For instance, messages can be sent to the target server (i.e., the server whose location is being determined) from test servers in New York City, San Francisco, Tokyo, and London. The elapsed time of the delay between the issuance of the request and receipt of the reply is determined for each of the four test servers. The delay between issuance of the request and receipt of a reply from the target server for each test server is indicative of the distance between that test server and the target server. The delay data for each test server can then be correlated to estimate the distance between the test server and the target server. A mathematical algorithm can then be employed to correlate the distance information for each test server to determine the location of the target server by trilateration.

There are many shortcomings of such geolocation techniques. For instance, the delay period does not necessarily correspond to the distance between the originating server and the target server because there are numerous factors in addition to the distance between two servers that can affect the delay. Furthermore, the geographic location of the server through which an individual accesses the Internet does not necessarily correspond to the geographic location of the individual. For instance, a large business enterprise might have one server at its headquarters through which all of its employees access the Internet, wherein employees could be located virtually anywhere in the world.

Another technique used to attempt to determine the geographic location of an Internet user is to maintain a list of the names and/or addresses of the registered owners of IP addresses and then assume that a user that accesses the Internet with a listed IP address is in the same geographic area as the owner of the IP address, i.e., the owner of the server that uses that IP address. However, this technique suffers from many of the same disadvantages noted above with respect to trilateration techniques as well as others. For instance, there is not necessarily a correlation between the address of the owner of the IP address and the location of the server, nor is there necessarily a correlation between the address of the owner of the IP address and users that access the Internet through the corresponding physical server.

### SUMMARY

Accordingly, it is a purpose of the present invention to provide an improved method and apparatus for geolocation of users of a communication network.

In accordance with the invention, a database correlating the self-reported geographic locations of users of a network (e.g., the Internet) to the network address (e.g., the IP address) through which the users access the network is developed. That database is used to infer the geographic location of other users who access the network through the same addresses as the users in the database. For instance, a Website operator on the Internet may generate the aforementioned database from geographic address information voluntarily provided by users of the website and their IP addresses (which are inherently available to the Website operator when a user accesses the website). If a plurality of users that access a Website through the same IP address have voluntarily provided information as to their geographic location (e.g., their home or business addresses, driver's license numbers or states, or phone numbers), that information collectively can be used to develop a reasonable estimate of the likely geographic location of users that access the network through that IP address as well as the size of the geographic area served by that IP address. Such information can be used to infer (1) the extent to which a given

IP address is likely to correlate to any particular geographic area and (2) the particular area, including its size. Thus, for instance, the database can be used to generate a table correlating a given IP address is to a plurality of increasingly larger, overlapping geographic areas (e.g., city, state, country, continent) that such users are inferred to be within and, for each such geographic area, a corresponding rating of how accurate any such inference is likely to be.

As an additional feature, if additional information about network users is available that is indicative of the veracity of the geographic location information self-reported by such users; it can also be correlated with the other data to provide an even more accurate estimate. For instance, Web retailers may be able to correlate SHIP TO data for items purchased by users with billing addresses for their credit card, debit card or other payment vehicle to infer the veracity of its users' reported locations. Alternately, some Website operators, such as eBay, maintain an extensive user feedback ratings database concerning the honesty of its registered users as reported by other users that have transacted business with such users. The user feedback ratings data can be independently correlated to generate a rating as to the likelihood that the self-reported location information for a given user is truthful. This veracity rating can then be correlated with the other aforementioned information (IP addresses and self-reported geographic location) to provide an even more accurate rating of the likelihood that the inferred location of users of a certain IP address is accurate.

BRIEF DESCRIPTION OF THE DRAWINGS

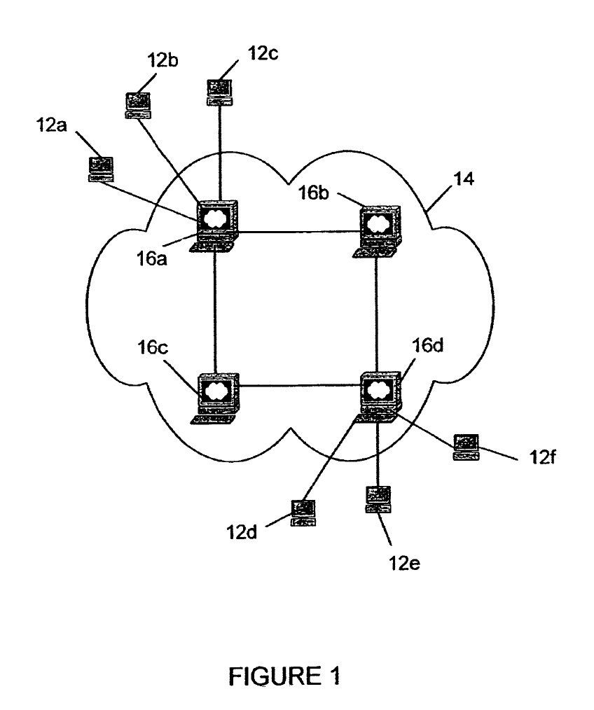

FIG. 1 is a block diagram of an exemplary large scale communication network, such as the Internet, in connection with which the present invention can be used.

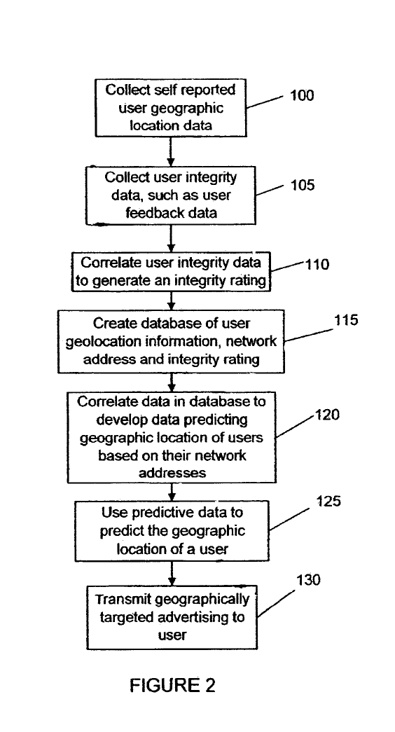

FIG. 2 is a flow diagram illustrating the steps involved in an exemplary embodiment of the present invention.

### DETAILED DESCRIPTION

FIG. 1 is a block diagram illustrating the basic components of a communications network. For exemplary purposes, the network 114 is the Internet. However, the network may be any communication network. The Internet is a vast collection of computing resources, interconnected as a network, from sites around the world. It is used every day by millions of individuals. The World Wide Web (referred to herein as the ‘Web”) is that portion of the Internet that uses the Hypertext Transfer Protocol (“HTTP”) as a protocol for exchanging messages. (Alternatively, the “HTTPS” protocol can be used, where this protocol is a security-enhanced version of HTIP.) Computers coupled to the Internet are assigned addresses and the various computers coupled to the Internet address each other using those addresses in accordance with the well-known Internet Protocol.

A user of the Internet commonly accesses and uses the Internet by establishing a network connection through the services of an Internet Service Provider (ISP). An ISP provides computer users at client machines 12 the ability to access a server computer 16 owned or managed by the ISP that is coupled to the Internet. The individual user's computer may connect to the IS P's server in any of a number of ways, such as through the local telephone lines, a local CATV cable or wirelessly through an antenna using radio waves.

Information content on the Internet is presented via pages, each page comprising a file that is stored on (or dynamically built by) a computer server that is coupled to the Internet and assigned a uniform resource locator (URL), which is convertible into a numerical, Internet Protocol address (hereinafter IP address). Servers, such as servers 116b and 116c, are computers on the network whose general purpose is to provide (or serve) information to other computers coupled to the network. Those computers that access information from servers via the network (e.g., the computer of a person surfing the Web) are typically termed client machines or client computers. Client machines are illustrated at 112a through 112e in FIG. 1.

The HTTP communication protocol uses a request/response paradigm, where the electronic messages sent between communicating computers can be categorized as either requests for information or responses to those requests. Generally, such requests and response will contain the IP address of the originating computer of the request or response (hereinafter, collectively “message”) and the IP address of the destination computer. A user working in a Web environment will have software running on his or her client computer to allow him or her to create and send requests for information onto the Internet, and to receive back and view the responses to the requests. These functions are typically combined in a software package that is referred to as a “Web browser”, or “browser”. After the user has created a request using the browser, the request message is sent out onto the Internet (typically, via an ISP, as described above). Such requests are routed through the Internet 114 to the server identified in the request (by its IP address). The target of the request message is one of the interconnected server computers 116 in the Internet network. That computer receives the message, attempts to find the data satisfying the user's request, formats that data for display with the user's browser, and returns the formatted response to the user's computer, where the user's browser software interprets the response and renders a display accordingly. This is an example of a client-server model of computing, where the computer at which the user requests information is referred to as the client or client machine, and the computer that locates the information and returns it to the client is referred to as the server or server machine. In the Web environment, the server is referred to as a “Web server”.

A particular embodiment of the invention will now be described in connection with the Internet as the exemplary communication network. However, it should be understood that the invention has much broader application and can be applied to virtually any communication network. As noted above, when one computer (e.g., the client machine in the example herein} sends a message (e.g., an HTTP request in this example) to another computer (e.g., the web site host server in this example} over the Internet, it provides its IP address to the other computer as part of that message's contents so that the web site host server will know the IP address of the requesting client machine in order to return-web pages, etc. to that client machine.

Depending on the type of connection to the Internet and possibly other factors, a given machine (e.g., a client machine) may have a dedicated IP address that never changes. However, in some types of connections, typically, dial-up connections (e.g., using a .v90 modem over telephone lines), the IP address assigned to the client machine may be different every time the client machine dials up into the Internet, but remains the same for any given dial-up session. However, even in dial-up type connections in which the IP address changes each session, typically, there is only a small, fixed range of IP addresses that can be assigned to the client machine. Particularly, the ISP's server through which the client accesses the Internet is assigned a plurality of fixed IP addresses that it can, in turn, assign to the clients that use that server to access the Internet. (Note that the computer provided by the ISP to act as a portal to the Internet for a plurality of client machines is still deemed a “server.”) Thus, even in the variable IP address, dial-up type situations, there typically is a set of known IP addresses that client machines accessing the Internet through a given server can be assigned.

There are a finite number of nodes (e.g., servers, routers) on the Internet. Particularly, it is believed that the Internet is designed to accommodate up to approximately 16 million nodes. However, only a fraction of that number are actually in use today. Some nodes comprise routers which, generally, help route data between servers. Some servers, such as those operated by ISPs, are the nodes through which client machines can connect to the Internet in order to be able to browse the Internet. Other server nodes, such as web host server nodes are used as data repositories that can be accessed by client machines via the Internet to retrieve information. For instance, a server that hosts one or more web sites is such a node. Each of these servers is assigned one or more particular IP addresses.

In normal browsing experiences on the Internet, users often self-report their geographic location to a web site. For instance, many web sites may simply ask the user to input information such as their home address, zip code, telephone number, driver's license data, and/or city and state (the area code and/or local exchange of a telephone number can be indicative of a geographic location, and a driver's license number can have a format indicative of the state, country or other geographic location of the issuing sovereignty). Often this is a condition of receiving some service from the web site, such as subscribing to an electronic newsletter or signing up to receive something such as free software or notifications of certain types of events, such as sales or current events. In addition, many web sites sell goods and services via the Internet. In order to purchase goods on a web site, it typically is necessary to input personal information, including home address, an address that the individual wants the purchased goods shipped to (hereinafter the SHIP TO address), a credit card number, etc. Accordingly, popular web sites (i.e., web sites that are visited by many people) can develop a very large database of geographic location information for users of the Internet. For instance, eBay, Inc., the assignee of the present patent application, operates a popular website known as eBay which provides its users the ability to list goods for sale or auction so that other users may bid on those goods, with the high bidder winning the auction and then purchasing the goods from the listing users for the high bid price.

At last count, eBay had over 68 million registered users, most, if not all, of which who have self-reported their home or business addresses. This provides an enormous database from which IP addresses can be correlated with geographic location data.

As previously noted, however, many people self-report home address and other information that is not truthful. Individuals may have various reasons for untruthfully reporting their address information, including privacy concerns and/or the fact that they are conducting fraudulent transactions over the Internet. Accordingly, it would be useful to have some additional indicia of the likelihood that a given individual has truthfully or untruthfully reported his or her personal information, including geographic location.

The eBay web site also provides a user feedback reputation feature. Particularly, users of the web site who have transacted business with other users of the web site are able to report on the users with which they have transacted business and rate those users. eBay maintains a database of the user feedback information for the purpose of allowing its users to determine the integrity of other eBay users that they may be considering transacting business with. The user feedback information includes a copy of each individual written review, a summary showing the total number of positive reviews, neutral reviews, and negative reviews, the number of those reviews in each of the three categories (positive, neutral, negative) that are from unique other users, and an overall, aggregate score. The overall score is calculated as the number of positive reviews from unique users minus the number of negative reviews from unique users, (i.e., each positive review from a unique user is counted as 1 point, each negative review from a unique user is counted as minus 1 point, and each neutral review from a unique user is counted as 0 points).

The user feedback information typically is highly indicative of the rated user's integrity, particularly as the number of individual ratings grows larger. Accordingly, users with very positive user feedback ratings from a large number of other users probably have accurately self-reported their home address information, while users with low user feedback ratings and/or only a small number of individual user ratings are less likely to have truthfully reported their home address information. Approximately 30 million registered eBay users have significant user feedback data.

A web site such as eBay with such a large number of registered users, who have self-reported their geographic location, is likely to have a large number of users at most well used nodes on the Internet. As previously noted, each node on the Internet has a given IP address or at least a predefined set of IP addresses (e.g., sequential numbers). Accordingly, an operator of a popular web site such as eBay has a database at its disposal that can be used to accurately correlate IP addresses to geographic locations virtually anywhere in the world. In addition, the user feedback ratings on eBay provide an extra layer of accuracy by providing further indicia of the probable integrity of the self-reported home address information. Hence, a database of users with self-reported address information as large as eBay's can be used to predict the geographic location of other users who have not self-reported their geographic location based on their IP addresses. A database of 30 million users, let alone 68 million users, should provide a sufficient number of users who are accessing the Internet through a very high percentage of the commonly used nodes on the Internet.

The embodiment of the invention described herein relates to a specific embodiment in which a web site operator has obtained such information from users of its web site. However, it should be understood that this is merely an example and that the invention would be applicable to any entity that could obtain sufficient information to generate statistically significant data correlating IP addresses to geographic locations of their users. In accordance with the invention, one or more databases are developed correlating the address (and/or other geographic data), IP address or addresses and, if available, an integrity rating for each user for which such information is available. The data in the database(s) can then be further correlated using any reasonable mathematical algorithm to predict a geographic area corresponding to an IP address or set of IP addresses.

Often, a given server (and thus a given IP address or set of related IP addresses) is used by an ISP or other entity to provide Internet access to a plurality of users in a defined geographic area. Thus, for many IP addresses or sets of IP addresses, the IP address correlates extremely well to a given geographic area of the users using that address(es). However, in many circumstances, a given IP address does not correlate to any particular geographic area or, alternately, may correlate to a very large geographic area, e.g., an entire country. For instance, as mentioned in the Background Section, a company with a large number of geographically remote employees that has an Intranet set up whereby all employees access the Internet through the same server regardless of where they are in the world would have very poor correlation between an IP address and any particular geographic location. The data developed in accordance with the present invention, however, would disclose which IP addresses do not correlate or correlate poorly to a geographic area and such information is useful in and of itself. For instance, one would know that geographically targeted advertising would likely be inappropriate for such IP addresses.

In one embodiment of the invention, the information is correlated to generate a geographic area to which an IP address is predicted to correspond and an accuracy rating indicative of the likelihood that a person accessing the Internet with that IP address is in the reported geographic location.

Merely as an example, let us consider a company that has its Intranet so that all of its employees access the Internet through a server in Chicago, Ill. Let us further assume that the company headquarters and 70% of its employees are in the Chicago area but that it has a remote sales force comprising 20% of its employees dispersed widely throughout the United States and another set of remote sales people comprising 10% of its employees who access the Internet dispersed widely throughout the world. Let us further assume that we have self-reported address information for a subset of this company's employees that perfectly reflects the distribution, i.e., 70% of the people are in the Chicago area, another 20% are in the United States, but not in the Chicago area, and another 10% are randomly dispersed throughout the world. Accordingly, the calculated data should indicate that the geographic area corresponding to the IP address or related set of IP addresses is Chicago and that the accuracy rating is 70%.

In another embodiment of the invention, for each IP address or set of IP addresses, multiple geographic locations can be provided for each IP address(es), each with an accuracy rating. In at least one embodiment of the invention, the multiple geographic areas comprise increasingly larger and completely overlapping areas. For example, the smallest area may be a city, the next larger area may be the state that the city is in, and the next larger area may be the country that the state is in. Thus, in the example given above, two geographic locations and corresponding accuracy ratings may be provided. In this example, Chicago would be the smaller area with an accuracy rating of 70% and the United States would be the larger area with an accuracy rating of 90%.

As previously noted, self-reported geographic location information is likely to be false information for some portion of users. The accuracy of the geographic location of prediction can be increased by further correlating the IP address information and self- reported geographic location information with further information that is indicative of the integrity of the self-reported information for a given user. In the eBay example discussed above, such information might be the user feedback rating. As another example, in the Internet retailing business, it is widely regarded to be a strong indicator of integrity when the address to which a person purchasing goods asks the goods to be shipped is the same as the billing address of the credit card, debit card or other payment vehicle used by that individual. Accordingly, the correlation of the “SHIP TO” address to the credit card “billing” address can be used as an integrity indicator which can be correlated with the other information to increase the accuracy of the accuracy rating. The manner in which such integrity data is correlated with the other data can be any reasonable manner. In one embodiment, if the SHIP TO address does not match the billing address, the user data may simply not be used in generating predictive geographic information.

In the eBay user feedback system, users with an average feedback rating below a certain value and/or with a number of individual user feedback ratings that is less than a predetermined number may be eliminated. Alternately, the integrity rating may be given a weight depending upon the number of individual user feedback ratings and/or aggregate feedback rating.

Many different algorithms can be used to correlate the IP address data with the geographic location data and/or the accuracy data. Described below is one particular exemplary algorithm based on the eBay example which correlates IP address information with self-reported home address information and an average user feedback rating to generate predictive geographic location information comprising two areas namely, state and country, and a predicted accuracy rating for each geographic area.

### Integrity Rating For Each User

Only users with a net positive overall user feedback rating are used. Each user with a net positive feedback score is assigned a Trust Weight as follows:

Trust Weight=Natural Logarithm of (Overall Feedback Score+1)

The Overall Feedback Score is used to assign a weight for each user's geolocation information. Instead of treating each user's information the same, Trust Weight is calculated for each user and used later to establish the predicted accuracy score of the predicted geolocation. The natural logarithm function is used to reduce the impact of populations with extremely high Overall Feedback Score.

### Geographic Location and Corresponding Predicted Accuracy Score Country

Country Predicted Accuracy Score=100*Confidence Upper Bound*Country Confidence Ratio

where Confidence Upper Bound=(1−(0.4/the number of users with that IP address)) and

Country Confidence Ratio=Total Trust Weight for users with that IP address in the selected country/Total Trust Weight of all users with that IP address.

Confidence Upper Bound (CUB) is introduced to reduce the noise from IP addresses that have only a few registered users. With the increase of the number of users, CUB values will increase from a starting value 0.60 to a maximum value of 1. For example, an IP address used by 10 users has a CUB value=1−0.4/10=0.96.

Country Confidence Ratio (CCR) is introduced to use Trust Weight values to assess the accuracy/confidence of each IP country location. The maximum possible value for CCR is 1 and the minimum is 0. The country with the highest CCR value is selected as the predicted country corresponding to that IP address.

### State

State Confidence Score=100*Confidence Upper Bound*State Confidence Ratio

where CUB value is defined the same as above and

State Confidence Ratio=Total Trust Weight of Selected IP State/Total IP address Trust Weight

State Confidence Ratio (SCR) is introduced to use Trust Weight values to assess the accuracy/confidence of each IP state location. The maximum possible value is 1 and the minimum is 0. The state with the highest CCR value is selected as the predicted state corresponding to that IP address.

### Revision Method

IP Address Reassignment Revision

In order to address the possibility of IP address reassignment, after the entire user database is used to derive IP address geolocation data, users who registered only in the last 365 days are used to derive the IP address geolocation data again. The original country and state predictions for a given IP address are compared to the newly determined country and state predictions, respectively. If one or both do not match and the predicted accuracy rating of the new predicted country and/ or state is over a predetermined threshold, the old data is replaced with the new IP address geolocation data for the particular IP address.

IP Address Cluster Verification

Those of skill in the related arts will recognize that there are different levels of IP addresses ranging from more specific to less specific. The algorithms outlined above may be used to calculate predicted countries and/or states (and corresponding predicted accuracy ratings) at different IP address levels. The consistency between the different IP address levels may be checked to improve the accuracy of the predicted IP address geolocation data. For example, if the predicted country for an IP address using all data corresponding to IP address level 2 is different than the predicted country for the IP address using all data corresponding to IP address level 3 and the Predicted Accuracy rating of the predicted country for the IP address level 3 data is low, the predicted country derived using the IP address level 2 prediction values (the predicted country and predicted accuracy values) may be used for IP address level 3, instead of the IP address level 3 predicted country information. For the same IP level, adjacent IP geo location information is clustered and used to improve the accuracy of current IP geolocation information.

### Flow Diagram

FIG. 2 is a flow chart illustrating use of the invention in an exemplary situation. First, in step 100, a web site operator collects the self-reported user geolocation data from its registered users as a function of IP address. In step 105, it collects data indicative of the likely integrity of the self-reported geolocation data. In the eBay user feedback information example, for example, this may be the average user feedback information. In step 110, the data for each given user is correlated to generate an integrity rating for that user which, for example, may be a single number from 1 to 5.

Next, in step 115, a database is created listing each user, the user's IP address or set of IP addresses, and the user's integrity rating.

In step 120, the data in the database is correlated to predict the geographic area corresponding to users who access the Internet through each given IP address. As previously noted, in at least one embodiment, this predictive data comprises one or more overlapping geographic areas, each area having a corresponding accuracy rating.

In step 125, when a user accesses the web site, the data is used to predict the location of that user based on his or her IP address. Finally, in step 130, some action is taken based on that prediction. In one simple example, the web site operator transmits geographically targeted advertising to the user based on the predicted geolocation.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

I/We claim:

1. A geographic location targeting system, comprising:
a database;
a communications interface that is coupled to a communications network;
a computing resource that is coupled to each of the communications interface and the database, wherein the computing resource is configured to:
receive, from a plurality of user devices through the communications network via the communications interface, geographic locations that are each associated with a network identifier;
store the geographic locations in the database;
store the network identifiers in the database;
determine a first subset of the network identifiers that are associated with a first geographic location; and
provide a first geographically targeting advertisement to a first user device in response to the first user device providing one of the first subset of the network identifiers.

2. The geographic location targeting system of claim 1, wherein the computing resource is configured to:
determine a second subset of the network identifiers that are associated with a second geographic location; and
provide a second geographically targeting advertisement that is different than the first geographically targeting advertisement to a second user device in response to the second user device providing one of the second subset of the network identifiers.

3. The geographic location targeting system of claim 1, wherein the computing resource is configured to:
determine the first subset of the network identifiers are associated with at least one geographic area that includes the first geographic location; and
determine an accuracy rating for each at least one geographic area.

4. The geographic location targeting system of claim 1, wherein the geographic locations received from the plurality of user devices are reported by a user of each of the plurality user devices.

5. The geographic location targeting system of claim 4, wherein the computing resource is configured to:
determine an integrity rating for each of the plurality of users; and
determine the likelihood that the geographic location reported by each user reflects an actual geographic location of that user using the integrity rating.

6. The geographic location targeting system of claim 1, wherein the computing resource is configured to:
determine that a first network identifier received with the first geographic location does not correlate with the first geographic location and, in response, not include the first network identifier in the first subset of network identifiers.

7. The geographic location targeting system of claim 6, wherein the computing resource is configured to:
receive the first network identifier from a second user device; and
not provide the first geographically targeting advertisement to a second user device in response to the first network identifier not correlating with the first geographic location.

8. A method for targeting based on a geographic location, comprising:
receiving, by a server machine from a plurality of client machines through a communications network, geographic locations that are each associated with a network identifier;
storing, by the server machine in a non-transitory memory system, the geographic locations;
storing, by the server machine in a non-transitory memory system, the network identifiers;
determining, by the server machine, a first subset of the network identifiers that are associated with a first geographic location; and
providing, by the server machine through the communications network, a first geographically targeting advertisement to a first client machine in response to the first client machine providing one of the first subset of the network identifiers.

9. The method of claim 8, further comprising:
determining, by the server machine, a second subset of the network identifiers that are associated with a second geographic location; and
providing, by the server machine through the communications network, a second geographically targeting advertisement to a second client machine in response to the second client machine providing one of the second subset of the network identifiers.

10. The method of claim 8, further comprising:
determining, by the server machine, the first subset of the network identifiers are associated with at least one geographic area that includes the first geographic location; and
determining, by the server machine, an accuracy rating for each at least one geographic area.

11. The method of claim 8, wherein the geographic locations received from the plurality of client devices are reported by a user of each of the plurality client devices.

12. The method of claim 8, wherein the geographic locations received from the client machine are reported by a user of the client machine, and the method further comprises:
determining, by the server machine, an integrity rating of each of the plurality of users; and
determining, by the server machine using the integrity rating, the likelihood that the geographic location reported by each user reflects an actual geographic location of that user.

13. The method of claim 8, further comprising:
determining, by the server machine, that a first network identifier received with the first geographic location does not correlate with the first geographic location and, in response, not include the first network identifier in the first subset of network identifiers.

14. A computer-implemented method performed by a computer system having an operatively interconnected processor, memory and communications interface, the method comprising:
receiving, from a plurality of user devices through a communications network via the communications interface, geographic locations that are each associated with a network identifier;
storing the geographic locations in the memory of the computer system;
storing the network identifiers in the memory of the computer system;
operating the processor of the computer system to determine a first subset of the network identifiers that are associated with a first geographic location; and
operating the processor of the computer system to provide a first geographically targeting advertisement to a first user device in response to the first user device providing one of the first subset of the network identifiers.

15. The computer-implemented method of claim 14, the method further comprising:
operating the processor to determine a second subset of the network identifiers that are associated with a second geographic location; and
operating the processor to provide a second geographically targeting advertisement to a second user device in response to the second user device providing one of the second subset of the network identifiers

16. The computer-implemented method of claim 14, the method further comprising:
operating the processor to determine the first subset of the network identifiers are associated with at least one geographic area that includes the first geographic location; and
operating the processor to determine an accuracy rating for each at least one geographic area.

17. The computer-implemented method of claim 14, wherein the geographic locations received from the plurality of user devices are reported by a user of each of the plurality user devices.

18. The computer-implemented method of claim 14, the method further comprising:
operating the processor to determine an integrity rating for each of the plurality of users; and
operating the processor to determine the likelihood that the geographic location reported by each user reflects an actual geographic location of that user using the integrity rating.

19. The computer-implemented method of claim 18, the method further comprising:
operating the processor to determine that a first network identifier received with the first geographic location does not correlate with the first geographic location and, in response, not including the first network identifier in the first subset of network identifiers

20. The computer-implemented method of claim 14, the method further comprising:
operating the processor to receive the first network identifier from a second user device; and
operating the processor to not provide the first geographically targeting advertisement to a second user device in response to the first network identifier not correlating with the first geographic location.
